(19) United States
(12) Patent Application Publication
(10) Pub. No.: US 2013/0067279 A1
(43) Pub. Date: Mar. 14, 2013

(54) TEST SYSTEM WITH MOTHERBOARD AND TEST CARD

(71) Applicants: TING GE, Shenzhen City (CN); YA-JUN PAN, Shenzhen City (CN)

(72) Inventors: TING GE, Shenzhen City (CN); YA-JUN PAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/570,234

(22) Filed: Aug. 8, 2012

(30) Foreign Application Priority Data
Sep. 14, 2011 (CN) 201110271245.4

(51) Int. Cl. G06F 11/273

(52) U.S. Cl. 714/27; 714/E11.17

(57) ABSTRACT

A test system includes a motherboard and a test card. The motherboard includes a number of electronic components and a first connector. The test card includes a second connector and a number of indicating circuits. The first connector includes a number of signal pins. Each signal pin of the first connector is connected to a corresponding signal terminal of the electronic components, to receive a power good signal. The second connector includes a number of signal pins. Each signal pin of the second connector is connected to a corresponding signal pin of the first connector, to receive a corresponding power good signal. Each indicating circuit is connected to a corresponding signal pin of the second connector, and indicates whether the corresponding signal pin of the second connector outputs a power good signal.

### BACKGROUND

1. Technical Field

The present disclosure relates to test systems, and more particularly to a test system including a motherboard and a test card.

2. Description of Related Art

In testing power good signals of electronic components, such as a central processing unit of a motherboard, a multimeter is usually employed to test each power terminal of each of the electronic components, which is a tedious and time-consuming procedure.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a test system in accordance with an exemplary embodiment of the present disclosure, wherein the test system includes a motherboard and a test card.

FIG. 2 is a circuit diagram of the motherboard of FIG. 1.

FIG. 3 is a circuit diagram of the test card of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

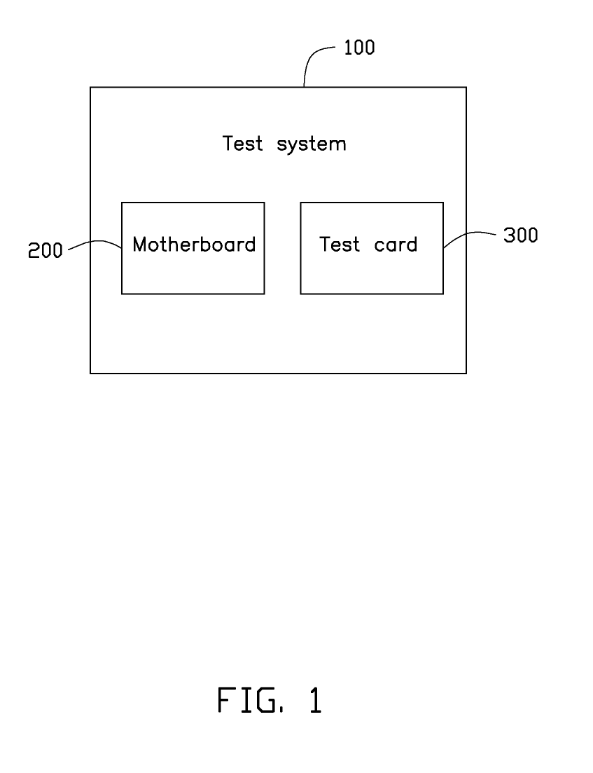

Referring to FIG. 1, an exemplary embodiment of a test system 100 is shown. The test system 100 includes a motherboard 200 and a test card 300. The test card 300 is used to test power signals output from the motherboard 200.

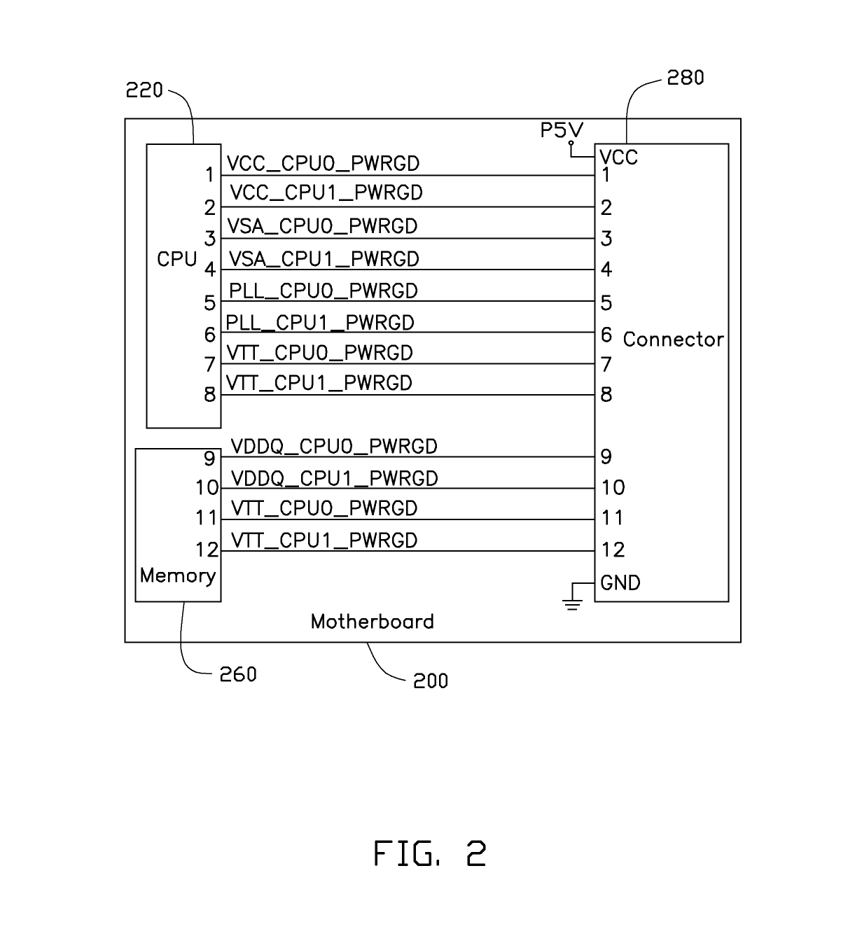

Referring to FIG. 2, the motherboard 200 of the embodiment is shown. The motherboard 200 includes a first electronic component, such as a central processing unit (CPU) 220, a second electronic component, such as a memory 260, and a connector 280.

The CPU 220 includes eight signal terminals 1-8. The signal terminal 1 of the CPU 220 is used to output a first power good signal VCC_CPU0_PWRGD. The signal terminal 2 of the CPU 220 is used to output a second power good signal VCC_CPU1_PWRGD. The signal terminal 3 of the CPU 220 is used to output a third power good signal VSA_CPU0_PWRGD. The signal terminal 4 of the CPU 220 is used to output a fourth power good signal VSA_CPU1_PWRGD. The signal terminal 5 of the CPU 220 is used to output a fifth power good signal PLL_CPU0_PWRGD. The signal terminal 6 of the CPU 220 is used to output a sixth power good signal PLL_CPU1_PWRGD. The signal terminal 7 of the CPU 220 is used to output a seventh power good signal VTT_CPU0_PWRGD. The signal terminal 8 of the CPU 220 is used to output an eighth power good signal VTT_CPU1_PWRGD. It is may be understood that each power good signal is a high level signal, such as logic 1.

The memory 260 includes four signal terminals 9-12. The signal terminal 9 of the memory 260 is used to output a ninth power good signal VDDQ_CPU0_PWRGD. The signal terminal 10 of the memory 260 is used to output a tenth power good signal VDDQ_CPU1_PWRGD. The signal terminal 11 of the memory 260 is used to output an eleventh power good signal VTT_CPU0_PWRGD. The signal terminal 12 of the memory 260 is used to output a twelfth power good signal VTT_CPU1_PWRGD. It is may be understood that each power good signal is a high level signal, such as logic 1.

The connector 280 includes eight first signal pins 1-8, four second signal pins 9-12, a power pin VCC, and a ground pin GND. The number of the first signal pins 1-8 of the connector 280 is equal to the number of the signal terminals 1-8 of the CPU 220, and the number of the second signal pins 9-12 of the connector 280 is equal to the number of the signal terminals 9-12 of the memory 260. Each of the first signal pins 1-8 is connected to a corresponding one of the signal terminals 1-8 of the CPU 220. Each of the second signal pins 9-12 is connected to a corresponding one of the signal terminals 9-12 of the memory 260. The power pin VCC is connected to a direct current power supply P5V. The ground pin GND is grounded.

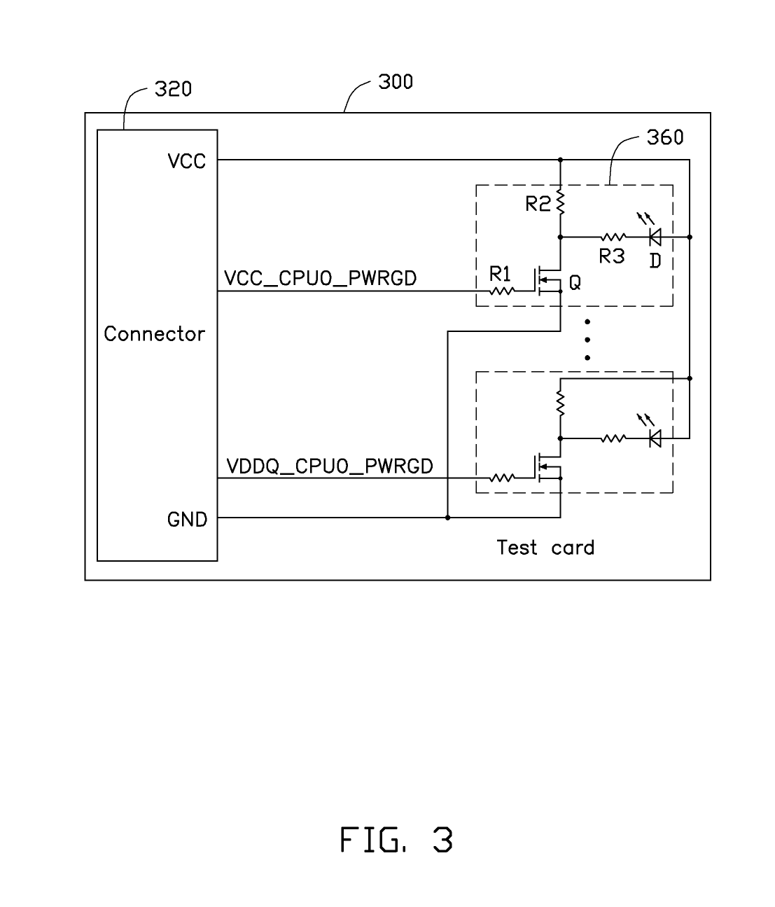

Referring to FIG. 3, the test card 300 includes a connector 320 and a plurality of indicating circuits 360. The number of the indicating circuits 360 is equal to the number of the signal pins 1-12 of the connector 280.

The connector 320 includes a plurality of signal pins, a power pin VCC, and a ground pin GND. The number of the signal pins of the connector 320 is equal to the number of the signal pins 1-12 of the connector 280. The connector 320 is connected to the connector 280. Each of the signal pins of the connector 320 is connected to a corresponding one of the signal pins of the connector 280, to receive a corresponding power good signal. The power pin VCC of the connector 320 is connected to the power pin VCC of the connector 280. The ground pin GND of the connector 320 is connected to the ground pin GND of the connector 280.

Each indicating circuit 360 is connected to one of the signal pins of the connector 320, to indicate whether the signal pin of the connector 320 receives the corresponding power good signal. Each indicating circuit 360 includes three resistors R1-R3, an electronic switch Q, and a light emitting element D. A control terminal of the electronic switch Q is connected to the corresponding signal pin of the connector 320 through the resistor R1. A power terminal of the electronic switch Q is connected to the power pin VCC of the connector 320 through the resistor R2. A ground terminal of the electronic switch Q is connected to the ground pin GND of the connector 320. A first terminal of the light-emitting element D is connected to the power terminal of the electronic switch Q through the resistor R3. A second terminal of the light emitting element D is connected to the power pin VCC of the connector 320.

In testing, the connector 320 of the test card 300 is connected to the connector 280 of the motherboard 200, to enable the test card 320 to communicate with the motherboard 320. If a core power VCORE of the CPU 220 is operating properly, the CPU 220 outputs the first power good signal VCC_CPU0_PWRGD through the signal terminal 1 of the CPU 220, and outputs the second power good signal VCC_CPU1_PWRGD through the signal terminal 2 of the CPU 220. The first power good signal VCC_CPU0_PWRGD is transmitted to a control terminal of a corresponding electronic switch Q through the signal terminal 1 of the CPU 220, the signal pin 1 of the connector 280, and a corresponding signal pin of the connector 320, to turn on the corresponding electronic switch Q. A corresponding light-emitting element D emits light to indicate the power good signal VCC_CPU0_PWRGD is output properly. The second power good signal VCC_CPU1_PWRGD is transmitted to a control terminal of a corresponding electronic switch Q through the signal terminal 2 of the CPU 220, the signal pin 2 of the connector 280, and a corresponding signal pin of the connector 320, to turn on the corresponding electronic switch Q. A corresponding light-emitting element D emits light to indicate the power good signal VCC_CPU1_PWRGD is output properly.

If the core power VCORE of the CPU 220 does not operate properly, the signal terminals 1 and 2 of the CPU 220 output two low level signals instead of the first and second power good signals VCC_CPU0_PWRGD and VCC_CPU1_PWRGD. The two low level signals are transmitted to the control terminals of the corresponding electronic switches Q through the connectors 280 and 330, to turn off the corresponding electronic switches Q. The corresponding light-emitting elements D do not emit light, thus indicating the first and second power good signals VCC_CPU0_PWRGD and VCC_CPU1_PWRGD are not output properly.

Similarly, other power good signals, such as the third to eighth power good signals VSA_CPU0_PWRGD, VSA_CPU1_PWRGD, PLL_CPU0_PWRGD, PLL_CPU1_PWRGD, VTT_CPU0_PWRGD, and VTT_CPU1_PWRGD of the CPU 220, and the ninth to twelfth power good signals VDDQ_CPU0_PWRGD, VDDQ_CPU1_PWRGD, VTT_CPU0_PWRGD, and VTT_CPU1_PWRGD of the memory 260, can be tested and the results know by observing whether the corresponding light-emitting elements D emit light or not.

In one embodiment, the memory 260 is a double data rate 3 dynamic random access memory (DDR3 DRAM). Each electronic switch Q is an n-channel metal-oxide semiconductor field-effect transistor (NMOSFET), the control terminal, the power terminal, and the ground terminal of each electronic switch Q are a gate, a drain, and a source of the NMOSFET. Each light-emitting element D is a light-emitting diode (LED), the first terminal and the second terminal of each light-emitting element D are respectively a cathode and an anode of the LED. In other embodiments, each electronic switch Q may be a p-channel MOSFET, or a transistor, or other switch having similar functions. The number of the electronic components of the motherboard 200, the number of the signal pins of the connectors 280 and 320, and the number of the indicating circuits 360 can be adjusted according to actual need.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A motherboard, comprising:
a plurality of electronic components, wherein each electronic component comprises a plurality of signal terminals, each signal terminal outputs a power good signal; and
a connector comprising:
a plurality of signal pins, wherein the number of the signal pins is equal to the number of the signal terminals of the electronic components, each signal pin is connected to a corresponding signal terminal of the electronic components to receive a corresponding power good signal;
a power pin connected to a direct current power supply; and
a ground pin grounded.

2. The motherboard of claim 1, wherein each power good signal is a high level signal.

3. A test card, comprising:
a first connector to be connected to a second connector of a motherboard, the first connector comprising:
a plurality of signal pins, wherein each signal pin is connected to a corresponding signal pin of the second connector, to receive a corresponding high level signal;
a power pin connected to a power pin of the second connector; and
a ground pin connected to a ground pin of the second connector; and
a plurality of indicating circuits, wherein the number of the indicating circuits is equal to the number of the signal pins of the first connector, each indicating circuit is connected to a corresponding signal pin of the first connector, and indicates whether the corresponding signal pin of the first connector outputs a high level signal.

4. The test card of claim 3, wherein each indicating circuit comprises:
first to third resistors;
an electronic switch comprising:
a control terminal connected to a corresponding signal pin of the first connector through the first resistor;
a power terminal connected to the power pin of the first connector through the second resistor; and
a ground terminal connected to the ground pin of the first connector; and
a light-emitting element comprising a first terminal connected to the power terminal of the electronic switch through the third resistor, and a second terminal connected to the power pin of the first connector.

5. The test card of claim 4, wherein each electronic switch is an n-channel metal-oxide semiconductor field-effect transistor (NMOSFET), the control terminal, the power terminal, and the ground terminal of each electronic switch are respectively a gate, a drain, and a source of the NMOSFET.

6. The test card of claim 4, wherein each light-emitting element is a light-emitting diode (LED), the first terminal and the second terminal of each light-emitting element are respectively a cathode and an anode of the LED.

7. A test system, comprising:
a motherboard comprising:
a plurality of electronic components, wherein each electronic component comprises a plurality of signal terminals, each signal terminal outputs a power good signal; and
a first connector comprising:
a plurality of signal pins, wherein the number of the signal pins is equal to the number of the signal terminals of the electronic components, each signal pin is connected to a corresponding signal terminal of the electronic components to receive a corresponding power good signal;
a power pin connected to a direct current power supply; and
a ground pin grounded; and
a test card comprising:
a second connector connected to the first connector, the second connector comprising:
a plurality of signal pins, wherein the number of the signal pins of the second connector is equal to the number of the signal pins of the first connector, each signal pin of the second connector is connected to a corresponding signal pin of the first connector to receive a corresponding power good signal;
a power pin connected to the power pin of the first connector; and
a ground pin connected to the ground pin of the first connector; and
a plurality of indicating circuits, wherein the number of the indicating circuits is equal to the number of the signal pins of the second connector, each indicating circuit is connected to a corresponding signal pin of the second connector, and indicates whether the corresponding signal pin of the second connector outputs a power good signal.

8. The test system of claim 7, wherein each indicating circuit comprises:
first to third resistors;
an electronic switch comprising:
a control terminal connected to a corresponding signal pin of the second connector through the first resistor;
a power terminal connected to the power pin of the second connector through the second resistor; and
a ground terminal connected to the ground pin of the second connector; and
a light-emitting element comprising a first terminal connected to the power terminal of the electronic switch through the third resistor, and a second terminal connected to the power pin of the second connector.

9. The test system of claim 8, wherein each electronic switch is an n-channel metal-oxide semiconductor field-effect transistor (NMOSFET), the control terminal, the power terminal, and the ground terminal of each electronic switch are respectively a gate, a drain, and a source of the NMOSFET.

10. The test system of claim 8, wherein each light-emitting element is a light-emitting diode (LED), the first terminal and the second terminal of each light-emitting element are respectively a cathode and an anode of the LED.

11. The test system of claim 7, wherein each power good signal is a high level signal.
